(19) United States
(12) Patent Application Publication
(10) Pub. No.: US 2012/0014451 A1
(43) Pub. Date: Jan. 19, 2012

(54) Image Encoding Methods, Image Decoding Methods, Image Encoding Apparatuses, and Image Decoding Apparatuses

(76) Inventors: Wei Siong Lee, Singapore (SG); Yih Han Tan, Singapore (SG); Jo Yew Tham, Singapore (SG); Kwong Huang Goh, Singapore (SG); Hai Gao, Singapore (SG)

(21) Appl. No.: 13/144,804

(22) PCT Filed: Jan. 15, 2010
(86) PCT No.: PCT/SG10/00010

§ 371 Date: Sep. 29, 2011

(30) Foreign Application Priority Data
Jan. 15, 2009 (US) 61/144851

(51) Int. Cl. H04N 7/32

(52) U.S. Cl. 375/240.16; 375/240.12; 375/E07.243

(57) ABSTRACT

In an embodiment, an image encoding method is provided. The image encoding method may include a first partial encoding step, wherein first partially encoded image data is generated based on first input data after the first input data is available; a second partial encoding step, wherein second partially encoded image data is generated based on second input data after the second input data is available, before the first input data is available; and an encoded image data generating step, wherein encoded image data is generated based on the first partially encoded image data and the second partially encoded image data.

### TECHNICAL FIELD

Embodiments relate generally to image encoding methods, image decoding methods, image encoding apparatuses, and image decoding apparatuses.

### BACKGROUND

Software-based realtime video encoding is challenging on current desktop computers due to the encoder complexity and the large amount of video data to be processed. The introduction of the H.264/AVC (Advanced Video Coding) have demonstrated significant improvement in video compression performance over previous coding standards such as H.263++ and MPEG-4. Recently, the Joint Video Team of the ITU-T VCEG and the ISO/IEC MPEG have also standardized the Scalable Video Coding (SVC) as an extension of the H.264/AVC standard to provide efficient support for spatial, temporal and quality scalability. Though video scalability techniques have been proposed in the past, such as the scalable profiles for MPEG-2, H.263, and MPEG-4 Visual, they are less efficient and more complex than the SVC. Coding efficiency gains of H.264 and SVC come with the price of high computational complexity, which is challenging for software encoders on the personal computers. The H.264 encoder is 8 times more complex than the MPEG-2 encoder, and 5 to 10 times more complex than the H.263 encoder. Furthermore, with the trend towards high definition resolution video, current high performance uniprocessor architectures are not capable of performing real-time encoding using H.264 or SVC. In W. S. Lee, Y. H. Tan, J. Y. Tham, K. Goh, and D. Wu, “Lacing an improved motion estimation framework for scalable video coding”, in: ACM International Conference on Multimedia, pp. 769-772, October 2008, a method of parallel encoding macroblocks has been investigated.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a flow diagram illustrating an image encoding method in accordance with an embodiment;

FIG. 2 shows a flow diagram illustrating an image decoding method in accordance with an embodiment;

FIG. 3 shows an image encoding apparatus in accordance with an embodiment;

FIG. 4 shows an image decoding apparatus in accordance with an embodiment;

FIG. 5 shows a diagram illustrating the data structure in Scalable Video Coding in accordance with an embodiment;

FIG. 6 shows a diagram illustrating a hierarchical B-pictures coding structure in accordance with an embodiment;

FIG. 7 shows a block diagram illustrating encoding with wavefront encoding;

FIG. 8 shows a diagram illustrating the dependencies between macroblocks;

FIG. 9 shows a diagram illustrating macroblock wavefront processing;

FIGS. 10A, 10B, 10C, 10D, 10E and 10F show various steps in a data partitioning method;

FIG. 11A shows a flow diagram illustrating a video encoding method;

FIG. 11B shows a flow diagram illustrating a video encoding method using functional partitioning;

FIG. 12 shows a task model for encoding each frame in accordance with an embodiment;

FIGS. 13A, 13B, 13C, 13D, 13E and 13F show various steps in a data and functional partitioning method in accordance with various embodiments;

FIG. 14 shows a graph illustrating the number of concurrent macroblock tasks in accordance with various embodiments;

FIG. 15 shows a graph indicating speedup vs. number of processors for wavefront encoding;

FIG. 16 shows a graph indicating speedup vs. number of processors for wavefront encoding;

FIG. 17 shows a graph indicating speedup vs. number of processors for wavefront encoding and temporal parallelization according to an embodiment;

FIG. 18 shows a graph indicating speedup vs. number of processors for wavefront encoding and temporal parallelization according to an embodiment;

FIG. 19 shows a graph indicating speedup vs. number of processors if tasks across quality layers are considered according to an embodiment; and

FIG. 20 shows an illustration of an inter-layer example in accordance with various embodiments.

### DESCRIPTION

In various embodiments, encoding of an image may be performed in various steps, for example forward motion estimation, backward motion estimation, and intra-prediction. In various embodiments, the encoding is parallelized by performing any one of the steps, for which the corresponding input data is available, even if input data for the other steps is not available. Thereby, encoding of an image may be started before all of the input data is available, which allows for a higher degree of parallelization compared to commonly used methods.

In various embodiments, an image may be an image that is part of a sequence of images.

In various embodiments, an image may be an image of a video sequence.

In various embodiments, each image may have relations to other images in temporal dimension, temporal direction or, time.

The following detailed description refers to the accompanying drawings that show, by way of illustration, specific details and embodiments in which the invention may be practiced. Other embodiments may be utilized and structural, logical, and electrical changes may be made without departing from the scope of the invention. The various embodiments are not necessarily mutually exclusive, as some embodiments can be combined with one or more other embodiments to form new embodiments. The following detailed description therefore, is not to be taken in a limiting sense, and the scope of the present invention is defined by the appended claims.

Various embodiments are provided for devices or apparatuses, and various embodiments are provided for methods. It will be understood that basic properties of the devices also hold for the methods and vice versa. Therefore, for sake of brevity, duplicate description of such properties may be omitted.

The word “exemplary” is used herein to mean “serving as an example, instance, or illustration”. Any embodiment or design described herein as “exemplary” is not necessarily to be construed as preferred or advantageous over other embodiments or designs.

The image encoding apparatus according to various embodiments may include a memory which is for example used in the processing carried out by the image encoding apparatus. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

The image decoding apparatus according to various embodiments may include a memory which is for example used in the processing carried out by the image decoding apparatus. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

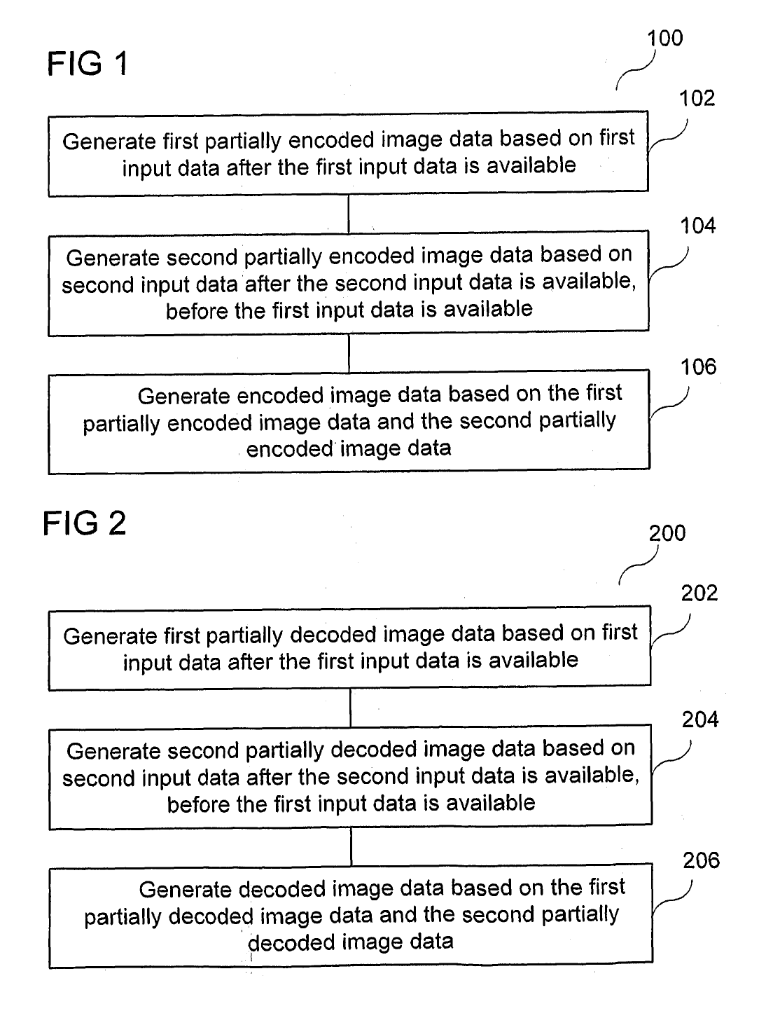

FIG. 1 shows a flow diagram 100 illustrating an image encoding method in accordance with an embodiment. In a first partial encoding step 102, partially encoded image data may be generated based on first input data after the first input data is available. In a second partial encoding step 104, second partially encoded image data may be generated based on second input data after the second input data is available, before the first input data is available. In an encoded image data generating step 106, encoded image data may be generated based on the first partially encoded image data and the second partially encoded image data.

In various embodiments, in the first partial encoding step 102, partially encoded image data may be generated based on first input data after the entire first input data is available.

In various embodiments, in the second partial encoding step 104, second partially encoded image data may be generated based on second input data after the entire second input data is available; before the entire first input data is available.

In various embodiments, the first input data may include at least one of encoded image data of a preceding image and encoded image data of a successive image.

In various embodiments, a preceding image may be an image that, in a temporal sequence of images to be encoded, is preceding the image currently to be encoded, while a successive image is succeeding the image currently to be encoded.

In various embodiments, the second input data may include at least one of encoded image data of a preceding image and encoded image data of a successive image.

In various embodiments, the first input data may include encoded image data of a preceding image and the second input data may include encoded image data of a successive image.

In various embodiments, the first input data may include encoded image data of a successive image and the second input data may include encoded image data of a preceding image.

In various embodiments, the first partial encoding step 102 may include at least one of a forward motion estimation step and a backward motion estimation step.

In various embodiments, the second partial encoding step 104 may include at least one of a forward motion estimation step and a backward motion estimation step.

In various embodiments, the first partial encoding step 102 may include a forward motion estimation step and the second partial encoding step 104 may include a backward motion estimation step.

In various embodiments, the first partial encoding step 102 may include a backward motion estimation step and the second partial encoding step 104 may include a forward motion estimation step.

In various embodiments, in a third partial encoding step, third partially encoded image data may be generated based on the first partially encoded image data and the second partially encoded image data. In various embodiments, in the encoded image data generating step 106, the encoded image data may be generated based on the first partially encoded image data, the second partially encoded image data and the third partially encoded image data.

In various embodiments, the third partial encoding step may include a bi-directional motion estimation step.

In various embodiments, the third partial encoding step may include an intra-prediction step.

In various embodiments, the encoded image data generated in the encoded image data generating step 106 may include at least one of encoded frame data, encoded slice data and encoded macroblock data. The various structures of frame data, slice data and macroblock data will be explained later in more detail.

FIG. 2 shows a flow diagram 200 illustrating an image decoding method in accordance with an embodiment. In a first partial decoding step 202, first partially decoded image data may be generated based on first input data after the first input data is available. In a second partial decoding step 204, second partially decoded image data may be generated based on second input data after the second input data is available, before the first input data is available. In a decoded image data generating step 206, decoded image data may be generated based on the first partially decoded image data and the second partially decoded image data.

In various embodiments, the first input data may include at least one of decoded image data of a preceding image and decoded image data of a successive image.

In various embodiments, the second input data may include at least one of decoded image data of a preceding image and decoded image data of a successive image.

In various embodiments, the first input data may include decoded image data of a preceding image and the second input data may include decoded image data of a successive image.

In various embodiments, the first input data may include decoded image data of a successive image and the second input data may include decoded image data of a preceding image.

In various embodiments, the first partial decoding step 202 may include at least one of a forward motion prediction step and a backward motion prediction step.

In various embodiments, the second partial decoding step 204 may include at least one of a forward motion prediction step and a backward motion prediction step.

In various embodiments, the first partial decoding step 202 may include a forward motion estimation step and the second partial decoding step 204 may include a backward motion estimation step.

In various embodiments, the first partial decoding step 202 may include a backward motion estimation step and the second partial decoding step 204 may include a forward motion estimation step.

In various embodiments, in a third partial encoding step, third partially decoded image data may be generated based on the first partially decoded image data and the second partially decoded image data. In various embodiments, in the decoded image data generating step 206, the decoded image data may be generated based on the first partially decoded image data, the second partially decoded image data and the third partially decoded image data.

In various embodiments, the decoded image data generated in the decoded image data generating step 206 may include at least one of decoded frame data, decoded slice data and decoded macroblock data.

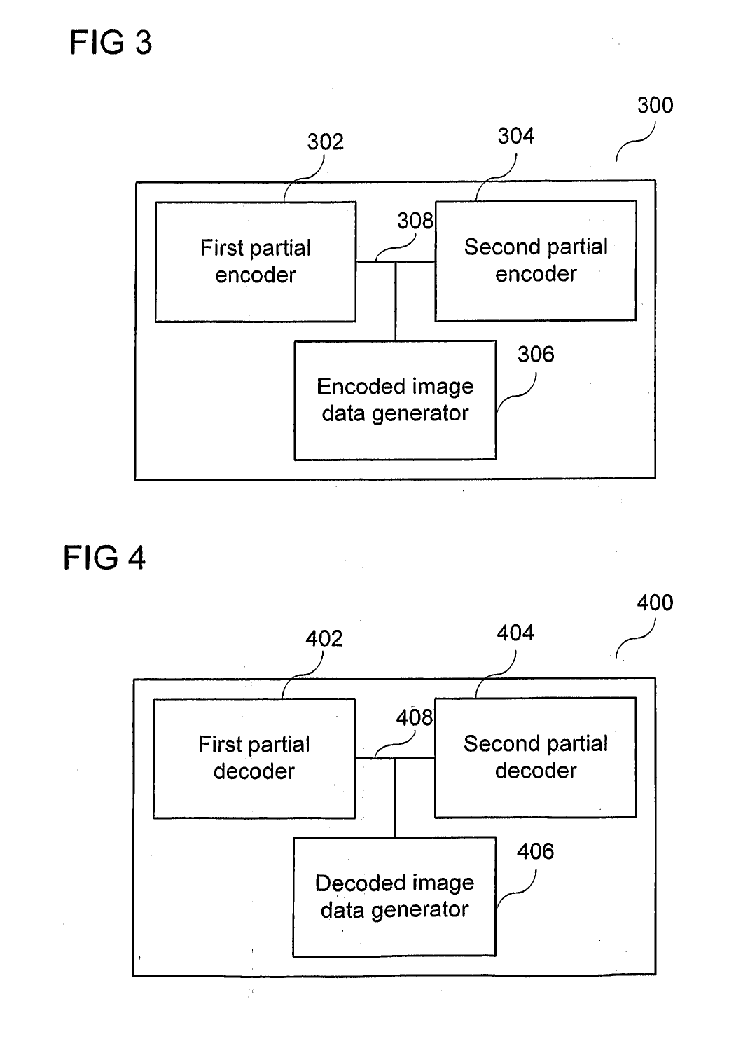

FIG. 3 shows an image encoding apparatus 300 in accordance with an embodiment. In various embodiments, the image encoding apparatus 300 may include a first partial encoder 302 configured to generate first partially encoded image data based on first input data after the first input data is available; a second partial encoder 304 configured to generate second partially encoded image data based on second input data after the second input data is available, before the first input data is available; and an encoded image data generator 306 configured to generate encoded image data based on the first partially encoded image data and the second partially encoded image data. The first partial encoder 302, the second partial encoder 304 and the encoded image data generator 306 may be coupled with each other, e.g. via an electrical connection 30S such as e.g. a cable or a computer bus or via any other suitable electrical connection to exchange electrical signals.

Although the first partial encoder 302, the second partial encoder 304 and the encoded image data generator 306 are shown as being separate in FIG. 3, any two or all of the first partial encoder 302, the second partial encoder 304 and the encoded image data generator 306 may be integrated into one device.

In various embodiments, the first input data may include at least one of encoded image data of a preceding image and encoded image data of a successive image.

In various embodiments, the second input data may include at least one of encoded image data of a preceding image and encoded image data of a successive image.

In various embodiments, the first input data may include encoded image data of a preceding image and the second input data may include encoded image data of a successive image.

In various embodiments, the first input data may include encoded image data of a successive image and the second input data may include encoded image data of a preceding image.

In various embodiments, the first partial encoder 302 may be configured to perform at least one of a forward motion estimation and a backward motion estimation.

In various embodiments, the second partial encoder 304 may be configured to perform at least one of a forward motion estimation step and a backward motion estimation step.

In various embodiments, the first partial encoder 302 may be configured to perform a forward motion estimation and the second partial encoder 304 may be configured to perform a backward motion estimation.

In various embodiments, the first partial encoder 302 may be configured to perform a backward motion estimation and the second partial encoder 304 may be configured to perform a forward motion estimation.

In various embodiments, the image encoding apparatus 300 may further include a third partial encoder (not shown) configured to generate third partially encoded image data based on the first partially encoded image data and the second partially encoded image data. In various embodiments, the encoded image data generator may be configured to generate the encoded image data based on the first partially encoded image data, the second partially encoded image data and the third partially encoded image data.

In various embodiments, the encoded image data generated by the encoded image data generator 306 may include at least one of encoded frame data, encoded slice data and encoded macroblock data.

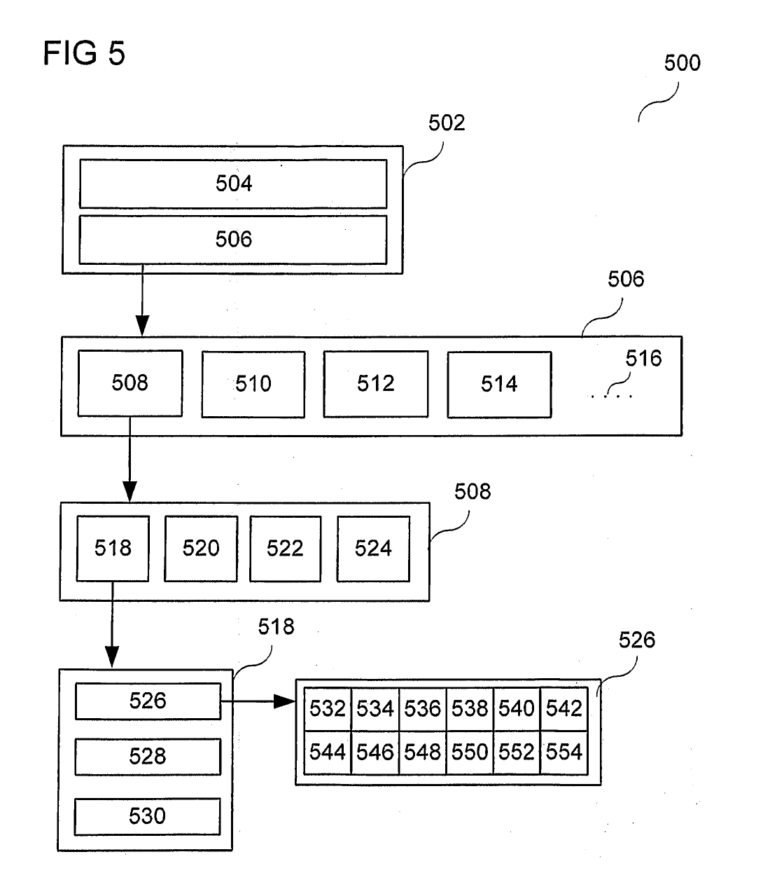

FIG. 4 shows an image decoding apparatus 400 in accordance with an embodiment. In various embodiments, the image decoding apparatus 400 may include a first partial decoder 402 configured to generate first partially decoded image data based on first input data after the first input data is available; a second partial decoder 404 configured to generate second partially decoded image data based on second input data after the second input data is available, before the first input data is available; and a decoded image data generator 406 configured to generate decoded image data based on the first partially decoded image data and the second partially decoded image data. The first partial decoder 402, the second partial decoder 404 and the decoded image data generator 406 may be coupled with each other, e.g. via an electrical connection 408 such as e.g. a cable or a computer bus or via any other suitable electrical connection to exchange electrical signals.

In various embodiments, the first input data may include at least one of decoded image data of a preceding image and decoded image data of a successive image.

In various embodiments, the second input data may include at least one of decoded image data of a preceding image and decoded image data of a successive image.

In various embodiments, the first input data may include decoded image data of a preceding image and the second input data may include decoded image data of a successive image.

In various embodiments, the first input data may include decoded image data of a successive image and the second input data may include decoded image data of a preceding image.

In various embodiments, the first partial decoder 402 may be configured to perform at least one of a forward motion prediction and a backward motion prediction.

In various embodiments, the second partial decoder 404 may be configured to perform at least one of a forward motion prediction and a backward motion prediction.

In various embodiments, the first partial decoder may 402 be configured to perform a forward motion prediction and the second partial decoder 404 may be configured to perform a backward motion prediction.

In various embodiments, the first partial decoder 402 may be configured to perform a backward motion prediction and the second partial decoder 404 may be configured to perform a forward motion prediction.

In various embodiments, the image decoding apparatus 400 may further include a third partial decoder (not shown) configured to generate third partially decoded image data based on the first partially decoded image data and the second partially decoded image data. In various embodiments, the decoded image data generator 406 may be configured to generate the decoded image data based on the first partially decoded image data, the second partially decoded image data and the third partially decoded image data.

In various embodiments, the decoded image data generated by the decoded image data generator 406 may include at least one of decoded frame data, decoded slice data and decoded macroblock data.

In various embodiments, an image encoding method may be provided, including a first partial encoding step, wherein first partially encoded image data is generated based on first input data as soon as the first input data is available; a second partial encoding step, wherein second partially encoded image data is generated based on second input data as soon as the second input data is available; and an encoded image data generating step, wherein encoded image data is generated based on the first partially encoded image data and the second partially encoded image data.

In various embodiments, an image decoding method may be provided, including a first partial decoding step, wherein first partially decoded image data is generated based on first input data as soon as the first input data is available; a second partial decoding step, wherein second partially decoded image data is generated based on second input data as soon as the second input data is available; and a decoded image data generating step, wherein decoded image data is generated based on the first partially decoded image data and the second partially decoded image data.

In various embodiments, an image encoding apparatus may be provided, including a first partial encoder configured to generate first partially encoded image data based on first input data as soon as the first input data is available; a second partial encoder configured to generate second partially encoded image data based on second input data as soon as the second input data is available; and an encoded image data generator configured to generate encoded image data based on the first partially encoded image data and the second partially encoded image data.

In various embodiments, an image decoding apparatus may be provided, including a first partial decoder configured to generate first partially decoded image data based on first input data as soon as the first input data is available; a second partial decoder configured to generate second partially decoded image data based on second input data as soon as the second input data is available; and a decoded image data generator configured to generate decoded image data based on the first partially decoded image data and the second partially decoded image data.

Software-based realtime video encoding may be challenging on current desktop computers due to the encoder complexity and the large amount of video data to be processed. Methods and apparatuses according to various embodiments may parallelize a video encoder to exploit multi-core architecture to scale its speed performance to available processors. Methods and apparatuses according to various embodiments may combine data and functional decomposition to yield as many concurrent tasks as possible to maximize processing scalability, i.e. the performance of the video encoder and decode may be enhanced, e.g. proportionally or almost proportionally, as more processors becomes available.

Coding efficiency gains of H.264 and SVC may come with the price of high computational complexity, which may be challenging for software encoders on the personal computers. The H.264 encoder is 8 times more complex than the MPEG-2 encoder, and 5 to 10 times more complex than the H.263 encoder. Furthermore, with the trend towards high definition resolution video, current high performance uniprocessor architecture may be not capable of performing real-time encoding using H.264 or SVC.

Various speed performance enhancing methods may be used for the H.264 encoder. In an example, complexity reduction algorithms may be used to minimize computations in the encoder. Examples are fast mode decisions and fast motion estimation techniques. These methods may compromise compressed video quality for speed. In another example, the encoder may be parallelized, as will be explained later.

All the performance optimization methods for H.264 may be applicable to SVC. However, the SVC may be at least a fold more computationally demanding than H.264 due to its additional coding modes specifically for inter-layer prediction, and the need to process multiple layers of video data. This added complexity to the SVC also may offer new task and data structures that are exploitable for encoder performance enhancements in terms of parallelization.

According to various embodiments, a method is provided to parallelize the hierarchical b-pictures (HB) encoding structure, as will be explained in more detail below, that may be used in the SVC for temporal scalability. It may be considered as a new coding structure that is introduced in SVC. By exploiting the HB structure, the methods according to various embodiments may maximize the number of concurrent encoding task in SVC, and thus may allow a parallelized SVC encoder that may scale well with additional processors.

FIG. 5 shows a diagram 500 illustrating the data structure in Scalable Video Coding (SVC) in accordance with an embodiment.

Video layers 502 at different resolutions may be provided, for example a first layer 504 (which may also be referred to as Layer 1) and a second layer 506 (which may also be referred to as Layer 0).

Each layer may include one or more groups of pictures (GOP). For example, for the second layer 506 the group of pictures in the layer are shown in FIG. 5. A first GOP 508 (which may also be referred to as GOP 0), a second GOP 510 (which may also be referred to as GOP 1), a third GOP 512 (which may also be referred to as GOP 2), and a fourth GOP 514 (which may also be referred to as GOP 3) may be provided. As indicated by dots 516, further GOPs may be provided. Although four GOPs are shown in FIG. 5, a layer may include any number of GOPs, either fixed for all layers, or varying from layer to layer.

Each GOP may include one or more frames. For example, for the first GOP 508, the frames in the GOP are shown in FIG. 5. A first frame 518 (which may also be referred to as Frame 0), a second frame 520 (which may also be referred to as Frame 1), a third frame 522 (which may also be referred to as Frame 2), and a fourth frame 524 (which may also be referred to as Frame 3) may be provided. Although four frames are shown in FIG. 5, a GOP may include any number of frames, either fixed for all GOPs, or varying from GOP to GOP.

Each frame may include one or more slices. For example, for the first frame 518, the slices in the frame are shown in FIG. 5. A first slice 526 (which may also be referred to as Slice 0), a second slice 528 (which may also be referred to as Slice 1), and a third slice 530 (which may also be referred to as Slice 2) may be provided. Although three slices are shown in FIG. 5, a frame may include any number of slices, either fixed for all frames, or varying from frame to frame. In various embodiments, the number of slices may be limited by the number of macroblocks, i.e. the number of slices may be smaller or equal to the number of macroblocks.

Each slice may include one or more macroblocks. For example, for the first slice 526, the macroblocks in the slice are shown in FIG. 5. A first macroblock 532 (which may also be referred to as Macroblock 0), a second macroblock 534 (which may also be referred to as Macroblock 1), a third macroblock 536 (which may also be referred to as Macroblock 2), a fourth macroblock 538 (which may also be referred to as Macroblock 3), a fifth macroblock 540 (which may also be referred to as Macroblock 4), a sixth macroblock 542 (which may also be referred to as Macroblock 5), a seventh macroblock 544 (which may also be referred to as Macroblock 6), an eighth macroblock 546 (which may also be referred to as Macroblock 7), a ninth macroblock 548 (which may also be referred to as Macroblock 8), a tenth macroblock 550 (which may also be referred to as Macroblock 9), an eleventh macroblock 552 (which may also be referred to as Macroblock 10), and a twelfth macroblock 554 (which may also be referred to as Macroblock 11) may be provided. Although twelve macroblocks are shown in FIG. 5, a slice may include any number of macroblocks, either fixed for all slices, or Varying from slice to slice.

In H.264 the same data structure as illustrated in FIG. 5 may be used, but without the video layers.

SVC may organize the compressed file into a base layer that is H264/AVC (Advanced Video Coding) encoded, and enhancement layers that may provide additional information to scale the base or preceding video layer in quality, spatial or temporal resolution. The original input video sequence may be down-scaled in order to obtain the pictures for all different spatial layers, which may result in spatial scalability. In each layer, a hierarchical B-pictures (HB) decomposition, which may also be referred to as a motion-compensated pyramid decomposition, may be performed for each group of pictures to provide temporal scalability.

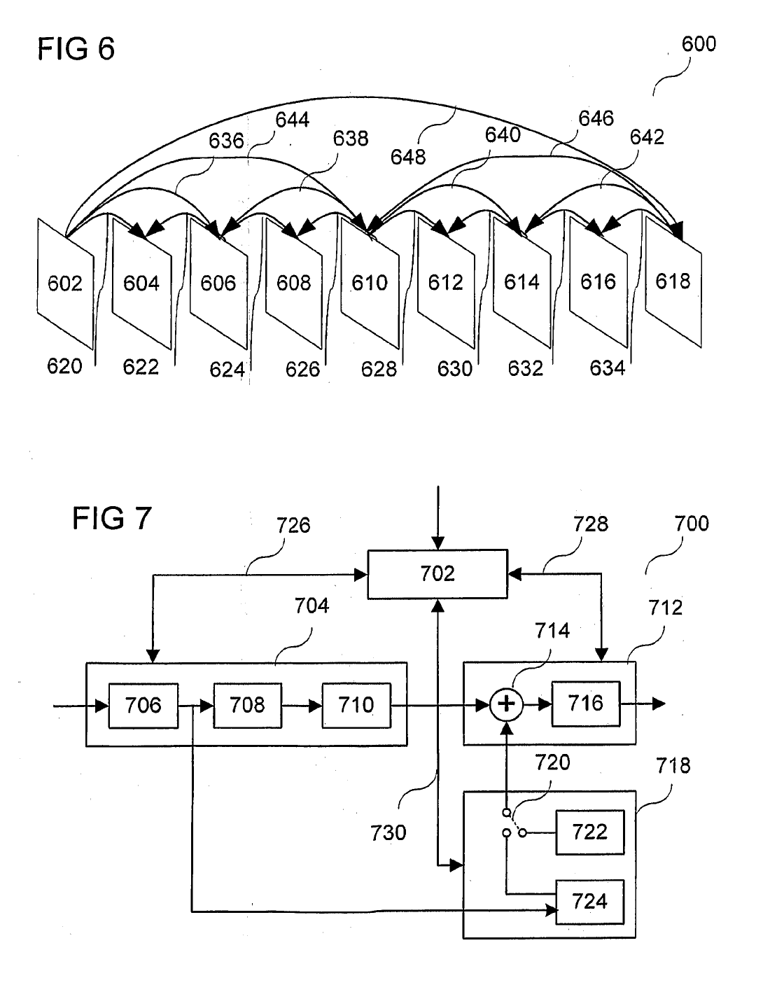

FIG. 6 shows a diagram 600 illustrating a hierarchical B-pictures coding structure in accordance with an embodiment. A first picture 602 (which in various embodiments may also be referred to as Frame 0), a second picture 604 (which in various embodiments may also be referred to as Frame 1), a third picture 606 (which in various embodiments may also be referred to as Frame 2), a fourth picture 608 (which in various embodiments may also be referred to as Frame 3), a fifth picture 610 (which in various embodiments may also be referred to as Frame 4), a sixth picture 612 (which in various embodiments may also be referred to as Frame 5), a seventh picture 614 (which in various embodiments may also be referred to as Frame 6), an eighth picture 616 (which in various embodiments may also be referred to as Frame 7) and a ninth picture 618 (which in various embodiments may also be referred to as Frame 8) are shown. Different kinds of picture may be provided. For example, I-, P, and B-pictures may be provided. I may denote an intra-coded picture, which may be coded independently from other pictures. Both P and B may denote inter-coded pictures, which may have dependency on previously coded pictures. In various embodiments, a P-picture may denote a picture that may have dependency on only a previously coded picture (for example a temporally preceding picture or a temporally succeeding picture), while a B-picture may denote a picture that may have dependencies on more than one previously coded picture (for example a temporally preceding picture and a temporally succeeding picture).

It will be understood that in various embodiments, a picture may be considered as being equivalent to a frame.

The second picture 604 to the ninth picture 618 may for a group of pictures of length 8.

For example, the first picture 602 may be an I-picture. It is to be noted that, for example in case where the first picture 602 preceding the present GOP, the first picture 602 may be a P-picture when seen from the previous GOP. Likewise, the ninth picture 618 may be considered a P-picture (for the present GOP) or an I-picture (for the succeeding GOP). For example, the second picture 604 to the eighth picture 616 may be B-pictures. In various embodiments, each of the first picture 602 and the ninth picture 618 (the last picture in the GOP) may either be a I-picture or P-picture. In various embodiments, the first frame of the first GOP may have to be an I-picture. Subsequently, the choice of I-picture or P-picture for the ninth picture 618 may be up to the encoder runtime configuration of the encoder. In various embodiments, a P-picture may be used. In various embodiments, an I-picture may be used when the encoder desires to remove any dependency between the current and next GOP. Examples of such a situation may be during scene change (for example for efficiency purposes) and due to encoder's parameter such as IDR Refresh Interval.

Thus, the second picture 604 may depend on the first picture 602 as shown by arrow 620 and on the third picture 604 as shown by arrow 622. Furthermore, the third picture 606 may depend on the first picture 602 as shown by arrow 636 and on the fifth picture 610 as shown by arrow 638. Furthermore, the fourth picture 608 may depend on the third picture 606 as shown by arrow 624 and on the fifth picture 610 as shown by arrow 626. Furthermore, the fifth picture 610 may depend on the first picture 602 as shown by arrow 644 and on the ninth picture 618 as shown by arrow 646. Furthermore, the sixth picture 612 may depend on the fifth picture 610 as shown by arrow 628 and on the seventh picture 614 as shown by arrow 630. Furthermore, the seventh picture 614 may depend on the fifth picture 610 as shown by arrow 640 and on the ninth picture 618 as shown by arrow 642. Furthermore, the eighth picture 616 may depend on the seventh picture 614 as shown by arrow 632 and on the ninth picture 618 as shown by arrow 634. Furthermore, the ninth picture 618 may depend on the first picture 602 as shown by arrow 648.

The display order of the first picture 602 to the ninth picture 618 may be 0, 1, 2, 3, 4, 5, 6, 7, 8, i.e. the first picture 602 may be displayed as 0^{th} picture, the second picture 604 may be displayed as the 1^{st} picture, the third picture 606 may be displayed as the 2^{nd} picture, the fourth picture 608 may be displayed as the 3^{rd} picture, the fifth picture 610 may be displayed as the 4^{th} picture, the sixth picture 612 may be displayed as the 5^{th} picture, the seventh picture 614 may be displayed as the 6^{th} picture, the eighth picture 616 may be displayed as the 7^{th} picture, and the ninth picture 618 may be displayed as the 8^{th} picture.

The coding order of the first picture 602 to the ninth picture 618 may be 0, 5, 3, 6, 2, 7, 4, 8, 1, i.e. the first picture 602 may be coded as 0^{th} picture, the second picture 604 may be coded as 5^{th} picture, the third picture 606 may be coded as 3^{rd} picture, the fourth picture 608 may be coded as 6^{th} picture, the fifth picture 610 may be coded as 2^{nd} picture, the sixth picture 612 may be coded as 7^{th} picture, the seventh picture 614 may be coded as 4^{th} picture, the eighth picture 616 may be coded as 8^{th} picture, and the ninth picture 618 may be coded as 1^{st} picture.

In the embodiment shown in FIG. 6, the pictures may be coded in four temporal levels: In the 0^{th} temporal level, the first picture 602 and the ninth picture 618 may be coded. In the 1^{st} temporal level, the fifth picture 610 may be coded. In the 2^{nd temporal level, the third picture 606 and the seventh picture 614 may be coded. In the} 3^{rd} temporal level, the second picture 604, the fourth picture 608, the sixth picture 612, and the eighth picture 616 may be coded.

In various embodiments, the number of possible temporal levels may be limited by the number of pictures in a GOP. For example, let N be number of pictures in GOP. Then the number of temporal level may range from 0 to T, where T=log 2(N) and T may be rounded down to the nearest integer.

SVC may use similar intra and inter-prediction techniques as in H.264/AVC for each picture frame. Additionally, in SVC, inter-layer prediction mechanisms may be used to reduce data redundancy between different layers. This may be achieved by reusing motion, residual and partitioning information of the lower spatial layers to predict enhancement layer pictures. When inter-layer prediction is used for a macroblock, only the residual signal (or prediction error) may be encoded. Such a macroblock is signaled by the syntax element base mode flag. The prediction mechanism used by a inter-layer predicted macroblock is determined by the mode of its corresponding 8×8 block in the reference layer.

An Inter-Layer Intra Prediction may be applied as follows: When the corresponding 8×8 block in the reference layer is intra-coded, the reconstructed data may be upsampled (for example by using a 4-tap FIR (finite impulse response) for luma samples and bilinear filter for chroma samples) and used as an intra prediction for the macroblock in the current layer.

An Inter-Layer Motion Prediction may be applied as follows: If the co-located 8×8 block in the reference layer is inter-coded, its motion and partitioning information may be scaled and used for the enhancement layer macroblock. Optionally, quarter-pel (quarter-pixel) motion vectors may be computed and coded for refinement since the motion vector of the previous layer has only up to half-pel precision in the current layer due to spatial resolution difference.

An Inter-Layer Residual Prediction may be applied as follows: Signaled by the syntax residual prediction flag, inter-coded macroblocks in the enhancement layer may utilize the bilinear-upsampled residual information of the co-located 8×8 block (intra or inter-coded) from the reference layer as prediction, so that only the difference signal may be coded in the enhancement layer.

In SVC four additional coding modes may be used specifically for macroblocks in the enhancement layers. Analysis performed on the SVC shows that, for encoding two spatial layers at CIF (Common Intermediate Format, for example corresponding to a resolution of 352 pixels×288 pixels) and QCIF (Quarter CIF, for example corresponding to a resolution of 176 pixels×144 pixels) resolutions, the intra and inter-frame coding may be respectively 13.04-28.00% (avg. 20.43%) and 58.06-259.95% (avg. 133.32%) more complex than without the inter layer prediction. In view of the complexity assessment in and the trend towards high definition (HD) video coding, where HD resolution is 9 to 20 times that of CIF resolution, it may be impossible for SVC encoding to achieve real-time performance on uni-processor architecture. However, with multiple-processors or multi-core technologies becoming increasingly common in consumer desktop computers, parallelizing the SVC encoder may be a feasible way to enhance its performance.

SVC may be considered as an extension of H.264. Thus parallelism techniques for H.264 encoder may also be applicable to it. The H.264 encoder may be parallelized either by task-level or data-level decomposition. For task-level decomposition, the H.264 encoding process may be partitioned into independent tasks such as the motion estimation and intra-prediction.

FIG. 7 shows a block diagram 700 illustrating encoding with wavefront encoding. An input video frame may be supplied to a master processor 702. The master processor 702 may be configured to control a first processor 704 as indicated by arrows 726, a second processor 712 as indicated by arrows 728, and a third processor 718 as indicated by arrows 730. Entropy decoding may be performed by entropy decoder 706. Inverse quantization may be performed by inverse quantizer 708, and inverse discrete cosine transform may be performed by inverse discrete cosine transformer 710. Addition may be performed by adder 714. Deblocking may be performed by deblocking filter 716. Motion compensation may be performed by motion compensator 724. Intra prediction may be performed by intra predictor 722. Selector 720 may select one of the motion compensation and intra prediction.

A speedup may be achieved with wavefront encoding. The encoding of a frame may start only after the encoding of the previous frame is finished.

Each task may represent a processing stage of the data and may be assigned to different thread/processor. There may be several difficulties of using task-level decomposition in parallelizing the video encoder. Scalability may be a problem in the task-level decomposition approach. Scalability may denote the quality of an application to expand efficiently to accommodate greater computing resources so as to improve application performance. One of the inhibiting factor to scalability may be that task-level decomposition may desire significant synchronization and communication between tasks for moving data from one processing stage to the other. Another factor may be load imbalance. It may be important to distribute work evenly across threads/processors to avoid blocking tasks. However, this may be very difficult because the execution time for each task depends on the nature of data being processed and is not known a priori. Thus for these difficulties, task-level decomposition may be not a popular approach to parallelize the H.264 encoder. A parallelization model for SVC encoder that may combine both the task-level and data-level decomposition will be discussed further below.

In a further approach using data-level decomposition, video data may be partitioned and assigned each to a different processor running the same task. The data structure used in the H.264 video coding may offer different levels of possible data partitioning, i.e. GOP, frame, slice and macroblock, each representing a successively finer data granularity.

On a GOP-level, video sequences may be processed and encoded as a series of GOPs in order to minimize memory load and exploiting inter-frame redundancy for compression. When the key frames of each GOP is an IDR (Instantaneous Data Refresh) picture, the GOPs may be independent and may be processed concurrently. This may be the coarsest grained parallelism for H.264 encoder. This approach may result in high-latency and memory consumption.

On a frame-level, the number of frames that can be coded concurrently may be determined by the prediction structure within each GOP. In H.264, frames, may be encoded using an IBBPBBP . . . structure where the B-pictures may be non-referenced and thus may be processed concurrently after their corresponding referenced P-pictures.

On a slice-level, in H.264 encoding, each picture frame may be partitioned into one or more slices in order to prevent error propagation across the frame in the presence of network transmission errors. Slices within each frame may be independent, i.e., no content of a slice may be used to predict elements of other slices in the same frame. Thus, all slices in the frame may be processed in parallel. The exploitable spatial data dependency within a picture may be limited as the number of slice increases and this may have an adverse effect on rate-distortion performance.

On a macroblock-level, each slice may be processed in blocks of 16×16 pixels called macroblocks. The macroblocks in a slice may be processed in scan order, i.e., top to bottom and left to right. Each macroblock may use information from the previously encoded macroblock for motion vector prediction, intra prediction, and deblocking.

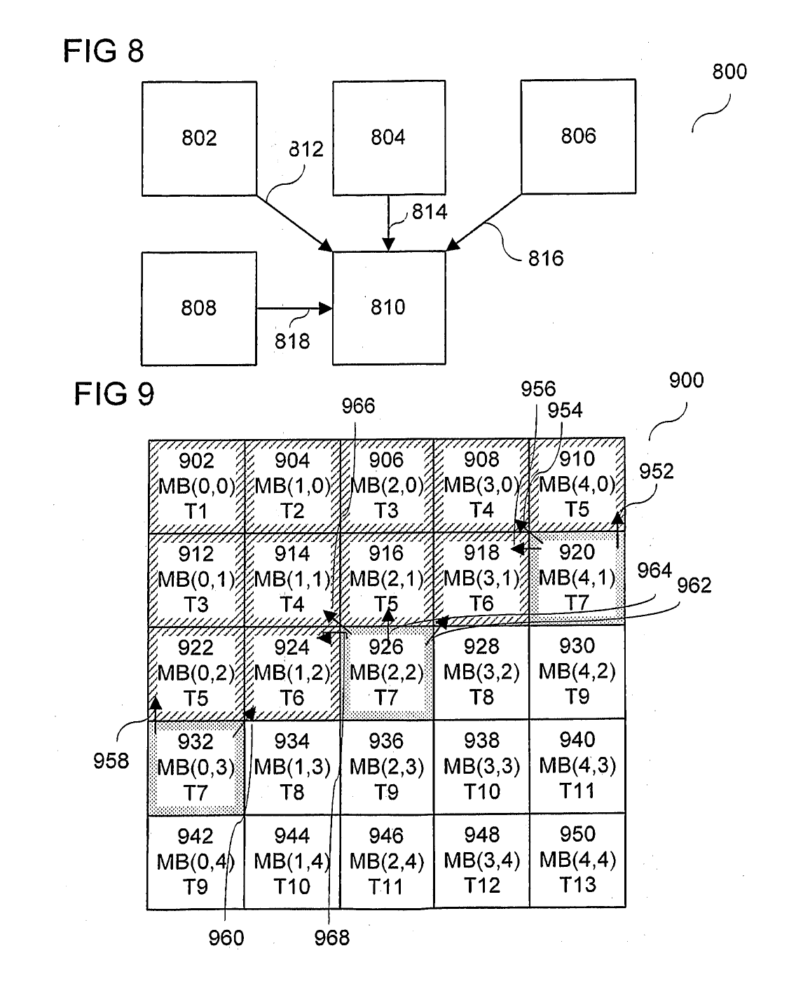

FIG. 8 shows a diagram 800 illustrating the dependencies, for example data and task dependencies, between macroblocks. A first macroblock 802, a second macroblock 804, a third macroblock 806, a fourth macroblock 808, and a fifth macroblock 810 may be provided. The first macroblock 802, the second macroblock 804, and the third macroblock 806 may be provided consecutively in a line, while the fourth macroblock 80S and the fifth macroblock 810 may also be provided consecutively in a line below. The fifth macroblock 810 may be the current macroblock. The task performed on the current macroblock 810 may be dependent on the decoded/reconstructed macroblocks, for example the first macroblock 802 as indicated by arrow 812, the second macroblock 804 as indicated by arrow 814, the third macroblock 806 as indicated by arrow 816, and the fourth macroblock 808 as indicated by arrow 818. For example, the first macroblock 802 may provide dependency to the current macroblock 810 for intra prediction and motion prediction. For example, the second macroblock 804 may provide dependency to the current macroblock 810 for intra prediction, motion prediction, and loop filtering. For example, the third macroblock 806 may provide dependency to the current macroblock 810 for intra prediction and motion prediction. For example, the fourth macroblock 808 may provide dependency to the current macroblock 810 for intra prediction, motion prediction, and loop filtering. Thus, for example, loop filtering on current macroblock 810 may require data from decoded second macroblock 804 and from decoded fourth macroblock 808.

FIG. 9 shows a diagram 900 illustrating macroblock wavefront processing. In FIG. 9, macroblocks 902 to 950 are shown. Each macroblock that has already been processed is shown as a processed macroblock by a hatched background (for example, macroblocks 902 to 918, and 922 and 924). Each currently processed macroblocks are shown as processing macroblock by a dotted background (for example macroblocks 920, 926 and 932). Un-processed macroblocks are shown by a plain background (for example macroblocks 928, 930, and 934 to 950).

For example with the dependencies shown in FIG. 8, currently processed macroblock 920 may be dependent on already processed macroblock 908 as indicated by arrow 954, dependent on already processed macroblock 910 as indicated by arrow 952, and dependent on already processed macroblock 918 as indicated by arrow 956. Furthermore, currently processed macroblock 926 may be dependent on already processed macroblock 914 as indicated by arrow 966, dependent on already processed macroblock 916 as indicated by arrow 964, dependent on already processed macroblock 918 as indicated by arrow 962, and dependent on already processed macroblock 924 as indicated by arrow 968. Furthermore, currently processed macroblock 932 may be dependent on already processed macroblock 922 as indicated by arrow 958 and dependent on already processed macroblock 924 as indicated by arrow 960.

In the macroblock wavefront example shown in FIG. 9 (with the notation that MB(x,y) denotes a macroblock with column-row position (x,y), and Tn, with an integer n denotes wavefront profile number), all macroblocks with the same wavefront profile number may be processed concurrently. Macroblocks may be processed in order of increasing wavefront profile numbers.

By processing the macroblocks in a wavefront order depicted in FIG. 9, groups of macroblock on the same wavefront order may be processed independently without breaking the dependencies. The wavefront may be expanded to include macroblocks in adjacent frames. This scheme may also be called 3D wavefront. The scalability of the 3D wavefront may be inversely proportional to the motion search range used by the encoder. Therefore, in order for 3D wavefront to be useful, the encoder may wish to restrict the motion search area, which may adversely affect the rate-distortion performance. Furthermore, in the case of SVC, where hierarchical B-pictures prediction structure may be used, the 3D wavefront may be unlikely to be a good approach since a smaller motion search range may have a greater impact on the encoder performance.

A single approach to parallelism may not offer good scalability on many-core architectures. Generally the solution may be to combine several levels of parallelism. Additionally, pixel-level parallelism may also be applied since most modern processors support SIMD (Single Instruction, Multiple Data) instruction set, which may allow multiple data elements to be processed concurrently with a single instruction. Pixel-level parallelism may be largely an implementation problem and it may be dependent on the CPU architecture platform, i.e., the same pixel-level parallelism technique may not be applied equally across different CPUs such as x86, PowerPC and the Cell processors

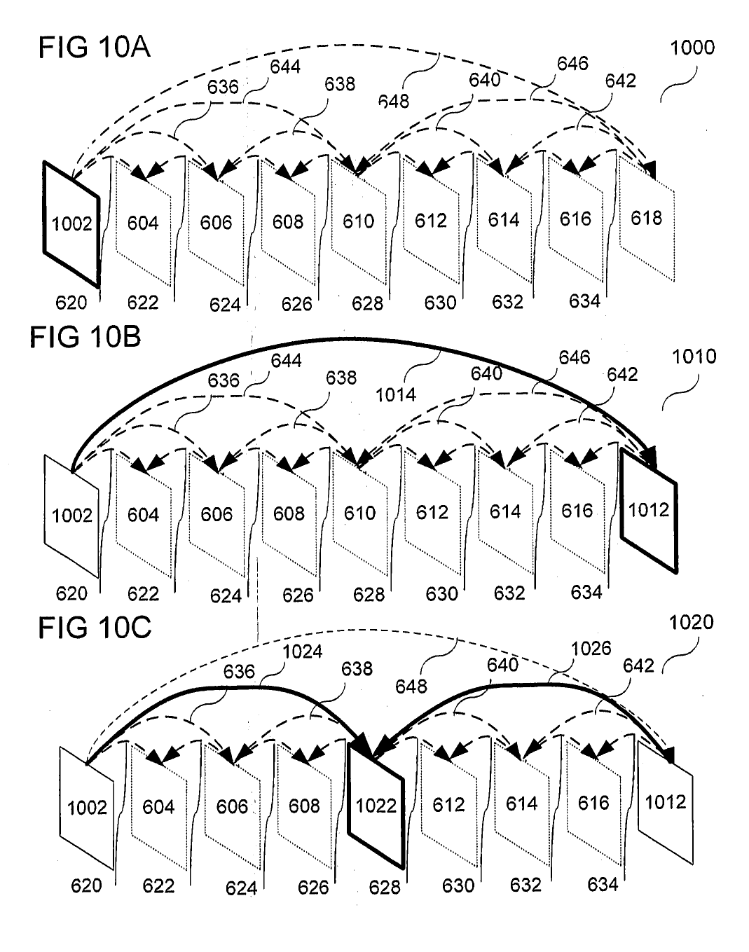

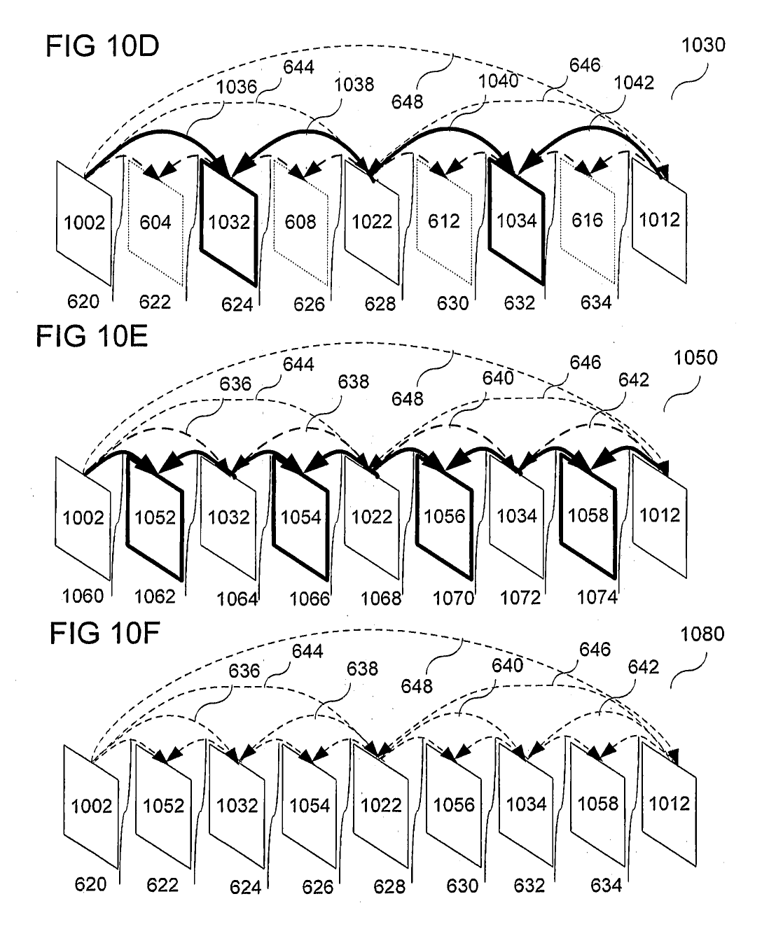

FIGS. 10A, 10B, 10C, 10D, 10E and 10F show various steps in a data partitioning method. According to the data partitioning method, each job may refer to processing one frame using macroblock (MB) wavefront. Independent frames may be processed concurrently. Each of the sub-figures of FIG. 10 shows the hierarchical B-pictures coding structure in accordance with an embodiment as shown in FIG. 6. Therefore, where applicable, the same reference signs as in FIG. 6 are used, and duplicate description is omitted here.

Throughout the sub-figures of FIG. 10, a dotted frame indicates a frame that has not yet been processed, a solid bold frame indicates a frame that is currently being processed, and a light solid frame indicates a frame that has already been processed.

In FIG. 10A a first step 1000 of processing (for example encoding, or for example decoding) is shown. In the first step 1000, the first frame 602 may be processed (for example encoded, or for example decoded), whereby a processed first frame 1002 may be generated. In the first step 1000, the number of concurrent jobs may be equal to 1×C_{wav}, where C_{wav} may denote the maximum macroblock concurrency in a frame and may be a constant dimension.

In FIG. 10B, a second step 1010 of processing (for example encoding, or for example decoding) is shown. In the second step 1010, the ninth frame 618 may be processed (for example encoded, or for example decoded), based on data of the processed first frame 1002 as indicated by arrow 1014, whereby a processed ninth frame 1012 may be generated. In the second step 1010, the number of concurrent jobs may be equal to 1×C_{wav}.

In FIG. 10C, a third step 1020 of processing (for example encoding, or for example decoding) is shown. In the third step 1020, the fifth frame 610 may be processed (for example encoded, or for example decoded), based on data of the processed first frame 1002 as indicated by arrow 1024, and based on data of the processed ninth frame 1012 as shown by arrow 1026, whereby a processed fifth frame 1022 may be generated. In the third step 1020, the number of concurrent jobs may be equal to 1×C_{wav}.

In FIG. 10D, a fourth step 1030 of processing (for example encoding, or for example decoding) is shown. In the fourth step 1030, the third frame 606 may be processed (for example encoded, or for example decoded), based on data of the processed first frame 1002 as indicated by arrow 1036, and based on data of the processed fifth frame 1022 as shown by arrow 1038, whereby a processed third frame 1032 may be generated. Furthermore, in the fourth step 1030, the seventh frame 614 may be processed (for example encoded, or for example decoded), based on data of the processed fifth frame 1022 as indicated by arrow 1040, and based on data of the processed ninth frame 1012 as shown by arrow 1042, whereby a processed seventh frame 1034 may be generated. In the fourth step 1030, the number of concurrent jobs may be equal to 2×C_{wav}.

In FIG. 10E, a fifth step 1050 of processing (for example encoding, or for example decoding) is shown. In the fifth step 1050, the second frame 604 may be processed (for example encoded, or for example decoded), based on data of the processed first frame 1002 as indicated by arrow 1060, and based on data of the processed third frame 1032 as shown by arrow 1062, whereby a processed second frame 1052 may be generated. Furthermore, in the fifth step 1050, the fourth frame 608 may be processed (for example encoded, or for example decoded), based on data of the processed third frame 1032 as indicated by arrow 1064, and based on data of the processed fifth frame 1022 as shown by arrow 1066, whereby a processed fourth frame 1054 may be generated. Furthermore, in the fifth step 1050, the sixth frame 612 may be processed (for example encoded, or for example decoded), based on data of the processed fifth frame 1022 as indicated by arrow 1068, and based on data of the processed seventh frame 1034 as shown by arrow 1070, whereby a processed sixth frame 1056 may be generated. Furthermore, in the fifth step 1050, the eighth frame 616 may be processed (for example encoded, or for example decoded), based on data of the processed seventh frame 1034 as indicated by arrow 1072, and based on data of the processed ninth frame 1012 as shown by arrow 1074, whereby a processed ninth frame 1058 may be generated. In the fifth step 1050, the number of concurrent jobs may be equal to 4×C_{wav}.

In FIG. 10F, a state 1080 after processing (for example encoding, or for example decoding) is done is shown, wherein the processed first frame 1002, the processed second frame 1052, the processed third frame 1032, the processed fourth frame 1054, the processed fifth frame 1022, the processed sixth frame 1056, the processed seventh frame 1034, the processed eighth frame 1058 and the processed ninth frame 1012 have been generated.

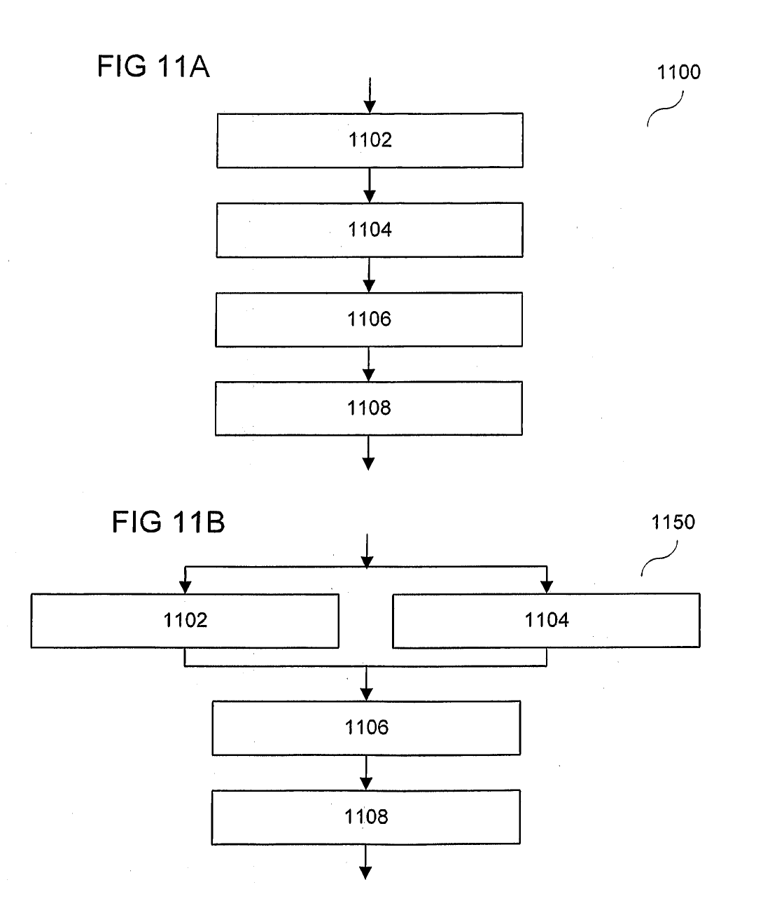

FIG. 11A shows a flow diagram 1100 illustrating a video encoding method. In FIG. 11A, the key tasks in processing a frame a illustrated. In 1102, forward motion estimation may be performed (which may also be referred to as L0_M1). In 1104, backward motion estimation may be performed (which may also be referred to as L1_ME). In 1106, bi-directional motion estimation may be performed (which may also be referred to as Bi_Pred). In 1108, intra-prediction may be performed (which may also be referred to as Intra_Pred). As shown in FIG. 11A, the steps may be performed sequentially, i.e. one after the other.

FIG. 11B shows a flow diagram 1150 illustrating a video encoding method using functional partitioning. The steps shown in the flow diagram 1150 are the same as those shown in FIG. 11A, and therefore, duplicate description is omitted. As shown in the flow diagram 1150, the independent tasks in a frame may be parallelized. For example, the forward motion estimation step 1102 may be performed in parallel to the backward motion estimation step 1104.

As already discussed above, parallelization methods for H.264 may be applicable to SVC. According to various embodiments, methods will be provided to exploit SVC's new coding structures in order to improve its scalability (processing) on multi-core computing platform.

Temporal scalability in SVC may be provided by the hierarchical B-pictures (HB) prediction structure as illustrated in FIG. 6. There may be two possible methods to parallel process frames in the HB structure. The first approach may be to concurrently process all frames belonging to the same temporal level since they have no inter-dependency. More concurrent tasks may be generated by incorporating the concept of task partitioning, where tasks within each macroblock may be decoupled. For example, forward and backward motion estimation may be performed independently. Therefore, there may be multiple wavefront processings for each frame, in which each wavefront may perform only specific encoding task. For P and B pictures, the intra-prediction may be performed after motion prediction to determine their encoded modes. By this arrangement, the wavefront of intra-prediction tasks may be decoupled without affecting the rate-distortion performance.

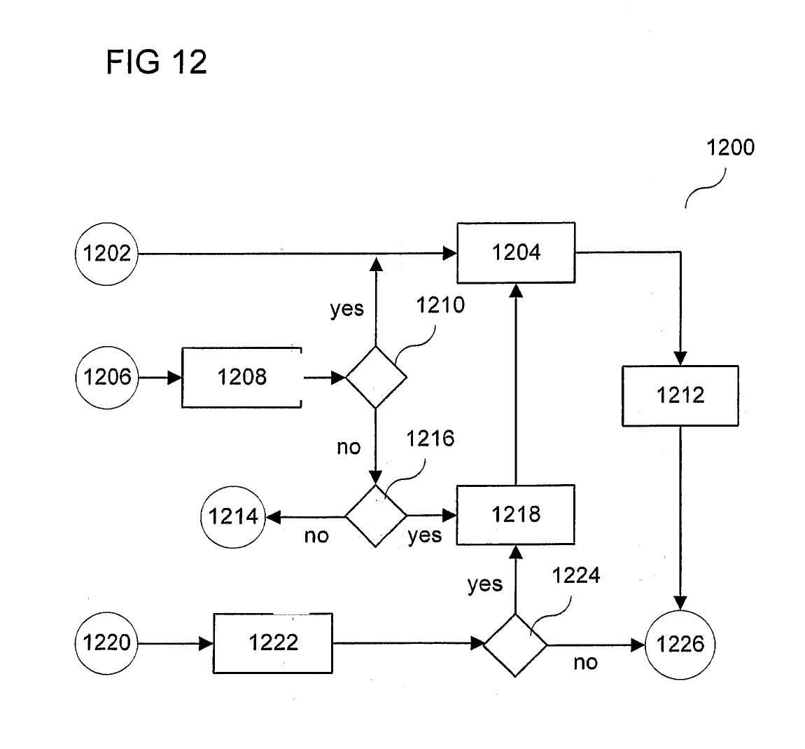

FIG. 12 shows a task model 1200 for encoding each frame in accordance with an embodiment. In other words, FIG. 12 shows a flow diagram for a frame task. There may be three modes for frame tasks, e.g. “Intra” denoting intra-prediction, “L0_ME” denoting motion estimation using L0 references and “L1_ME” denoting motion estimation using L1 references. In various embodiments, L0 and L1 may denote a zeroth List 0 and first List 1. These terms may be used where each list may include indexes of reference frames for the current frame. List 0 may be used for forward motion estimation (ME) and List 1 may be used for backward ME. Hence, frames in L0 are in the ‘past’ relative to current frame; and frames in L1 are in the ‘future’ relative to current frame.

In 1202, an intra prediction frame task (which may also be referred to as Frame_Task(Intra)) may be started. In 1206, a forward motion estimation task (which may also be referred to as Frame_Task(L0_ME)) may be started. In 1220, a backward motion estimation task (which may also be referred to as Frame_Task(L1_ME)) may be started.

In 1214, processing may end. Likewise, in 1226 processing may end.

In 1204, an intra prediction task (which may be also referred to as MB_Task₀(0,0,Intra_Pred)) may be spawned (in other words: started).

In 1212 children tasks (which may also be referred to as children Frame_task), for example, tasks, for which input data is now available, may be spawned. In 1208, a forward motion estimation task (which may also be referred to as MB_Task₀(0,0,L0_ME)) may be spawned. In 1222, a backward motion estimation task (which may also be referred to as MB_Task₀(0,0,L1_ME)) may be spawned. In 1218, a bi-directional motion estimation task (which may also be referred to as MB_Task₀(0,0,Bi_Pred)) may be spawned.

In 1210, it may be checked whether the frame is a P frame. In case it is a P-frame (yes), processing may continue in 1204, where an intra prediction task (which may be also referred to as MB_Task₀(0,0,Intra_Pred)) may be spawned. In case it is not a P-frame (no), processing may continue with the check 1216.

In 1216, it may be checked, whether backward motion estimation has been done (e.g. whether L1_ME has been done). In case backward motion estimation has not been done (no), processing ends in 1214. In case backward motion estimation has been done (yes), processing continues in 1218, where a bi-directional motion estimation task (which may also be referred to as MB_Task₀(0,0,Bi_Pred)) may be spawned.

In 1214, it may be checked, whether forward motion estimation has been done (e.g. whether L0_ME has been done). In case forward motion estimation has not been done (no), processing ends in 1226. In case forward motion estimation has been done (yes), processing continues in 1218; where a bi-directional motion estimation task (which may also be referred to as MB_Task₀(0,0,Bi_Pred)) may be spawned.

It is to be noted, that intra prediction task spawning task 1204, forward motion estimation task spawning task 1208, bi-directional motion estimation task spawning task 1218 and backward motion estimation task spawning task 1222 may be considered as macroblock wavefront tasks.

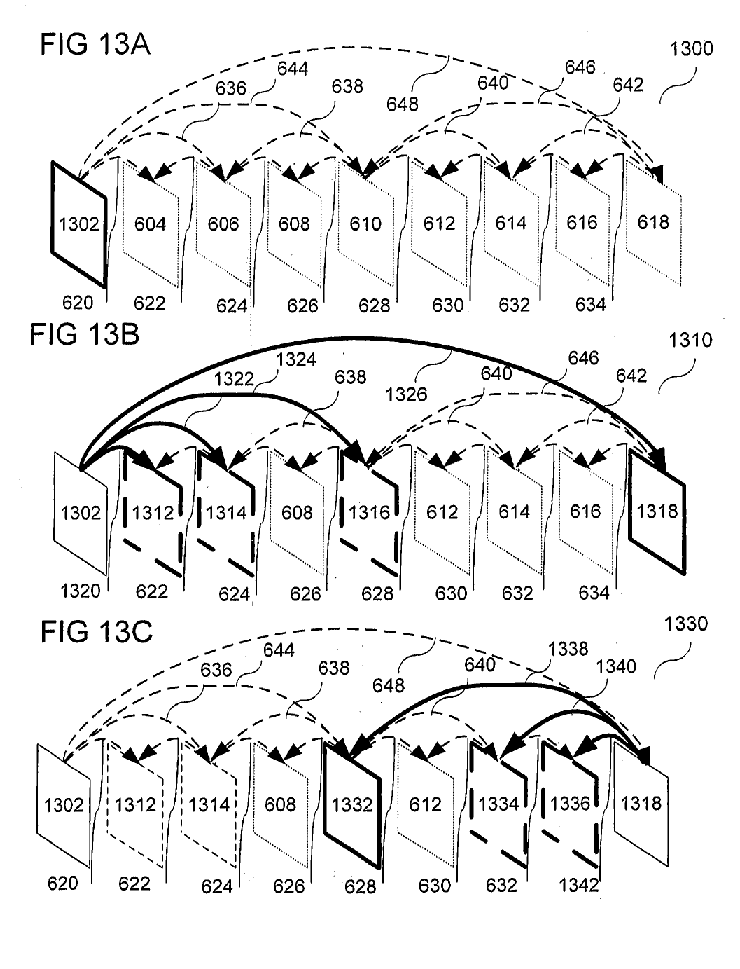

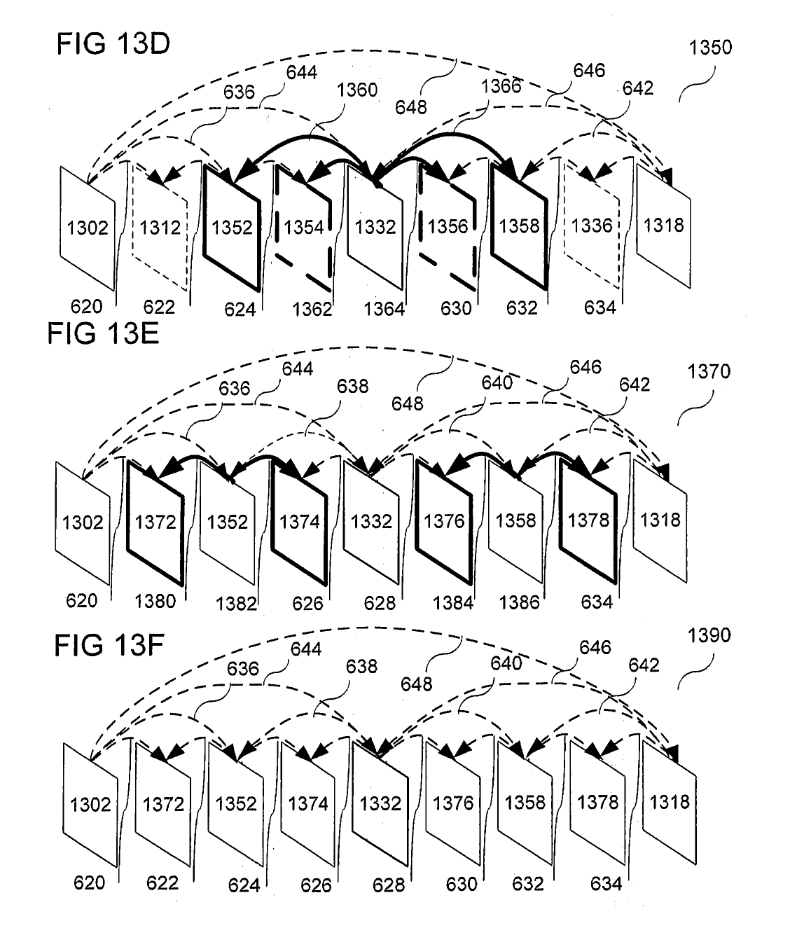

FIGS. 13A, 13B, 13C, 13D, 13E and 13F show various steps in a data and functional partitioning method in accordance with various embodiments. In accordance with various embodiments, data and functional partitioning may be applied, wherein different tasks in each frame may have different dependencies, and the tasks for which the dependency is satisfied may be executed. Each of the sub-figures of FIG. 13 shows the hierarchical B-pictures coding structure in accordance with an embodiment as shown in FIG. 6. Therefore, where applicable, the same reference signs as in FIG. 6 are used, and duplicate description is omitted here.

Throughout the coding example using the task model in accordance with an embodiment shown in FIGS. 13A, 13B, 13C, 13D, 13E and 13F, a dotted frame indicates a frame that has not yet been processed, a bold dashed frame indicates a frame that is currently been partially processed without being completely processed, a light dashed frame indicates a frame that has been partially processed (i.e. a frame that is partially completed), a solid bold frame indicates a frame that is currently being processed so as to be completely processed, and a light solid frame indicates a frame that has already been completely processed.

In various embodiments, each frame may have a set of data which may record results from different stages of processing. This may be for the purpose of picking the best result when all necessary processing stage is completed. Two of the key information recorded may be ‘distortion’ (which may measure the quality of the processing) and ‘rate’ (which may measure the cost of resource required to achieve the corresponding level of ‘distortion’). Other parameters may depend of the processing stage, which essentially may include parameters derived from the processing stage that may lead to the corresponding ‘distortion’ and ‘rate’. For example L0_ME may have ‘motion vector’ and ‘partitioning mode’ information; Intra_Pred stage may have ‘intra-prediction mode’ information.

In FIG. 13A, a first step 1300 of processing (for example encoding, or for example decoding) is shown. In the first step 1300, the first frame 602 may be processed (for example encoded using intra coding using macroblock wavefront, where each macroblock is intra-predicted (for example by execution of a task Intra_Pred, for example a task Frame_Task(Intra)), or for example decoded using intra-prediction), whereby a processed first frame 1302 may be generated. In the first step 1300, the number of concurrent jobs may be equal to 1×C_{wav}, where C_{wav} may denote the maximum macroblock concurrency in a frame and may be a constant dimension.

In FIG. 13B, a second step 1310 of processing (for example encoding, or for example decoding) is shown. In the second step 1310, the second frame 604 may be partially processed (for example encoded using forward motion estimation using macroblock wavefront (for example by execution of a task L0_ME, for example a task Frame_Task(L0_ME)), or decoded using forward motion prediction), based on data of the processed first frame 1302 as indicated by arrow 1320, whereby a partially completed second frame 1312 may be generated. Furthermore, in the second step 1310, the third frame 606 may be partially processed (for example encoded using forward motion estimation using macroblock wavefront (for example by execution of a task L0_ME, for example a task Frame_Task(L0_ME)), or decoded using forward motion prediction), based on data of the processed first frame 1302 as indicated by arrow 1322, whereby a partially completed third frame 1314 may be generated. Furthermore, in the second step 1310, the fifth frame 610 may be partially processed (for example encoded using forward motion estimation using macroblock wavefront (for example by execution of a task L0_ME, for example a task Frame_Task(L0_ME)), or decoded using forward motion prediction), based on data of the processed first frame 1302 as indicated by arrow 1324, whereby a partially completed fifth frame 1316 may be generated. Furthermore, in the second step 1310, the ninth frame 618 may be processed (for example encoded using forward motion estimation and intra prediction (for example by execution of tasks L0_ME and Intra_Pred, for example a task Frame_Task(L0_ME)), or decoded using forward motion prediction and intra prediction), based on data of the processed first frame 1302 as indicated by arrow 1326, whereby a processed (for example completely encoded) ninth frame 1318 may be generated. In the second step 1310, the number of concurrent jobs may be equal to 4×C_{wav}.

In FIG. 13C, a third step 1330 of processing (for example encoding, or for example decoding) is shown. In the third step 1330, the partially completed fifth frame 1316 may be processed (for example encoded using backward motion estimation using macroblock wavefront and intra-prediction (for example by execution of tasks L1_ME and Intra_Pred, for example a task Frame_Task(L1_ME)), or decoded using backward motion prediction and intra-prediction), based on data of the processed ninth frame 1318 as indicated by arrow 1338, whereby a processed fifth frame 1332 (for example a completely encoded frame) may be generated. Furthermore, in the third step 1330, the seventh frame 614 may be partially processed (for example encoded using backward motion estimation using macroblock wavefront (for example by execution of a task L1_ME, for example a task Frame_Task(L1_ME)), or decoded using backward motion prediction), based on data of the processed ninth frame 1318 as indicated by arrow 1340, whereby a partially completed seventh frame 1334 may be generated. Furthermore, in the third step 1330, the eighth frame 616 may be partially processed (for example encoded using backward motion estimation using macroblock wavefront (for example by execution of a task L1_ME, for example a task Frame_Task(L1_ME)), or decoded using backward motion prediction); based on data of the processed ninth frame 1318 as indicated by arrow 1342, whereby a partially completed eighth frame 1336 may be generated. In the third step 1330, the number of concurrent jobs may be equal to 3×C_{wav}.

In FIG. 13D, a fourth step 1350 of processing (for example encoding, or for example decoding) is shown. In the fourth step 1350, the partially completed third frame 1314 may be processed (for example encoded using backward motion estimation using macroblock wavefront and intra-prediction (for example by execution of tasks L1_ME and Intra_Pred), or decoded using backward motion prediction and intra-prediction), based on data of the processed fifth frame 1332 as indicated by arrow 1360, whereby a processed third frame 1352 (for example a completely encoded frame) may be generated. Furthermore, in the fourth step 1350, the fourth frame 608 may be processed (for example encoded using backward motion estimation using macroblock wavefront (for example by execution of tasks L1_ME), or decoded using backward motion prediction), based on data of the processed fifth frame 1332 as indicated by arrow 1362, whereby a partially completed fourth frame 1354 may be generated. Furthermore, in the fourth step 1350, the sixth frame 612 may be processed (for example encoded using forward motion estimation using macroblock wavefront (for example by execution of tasks L0_ME), or decoded using forward motion prediction), based on data of the processed fifth frame 1332 as indicated by arrow 1364, whereby a partially completed sixth frame 1356 may be generated. Furthermore, in the fourth step 1350, the partially completed seventh frame 1334 may be processed (for example encoded using forward motion estimation using macroblock wavefront and intra-prediction (for example by execution of tasks L0_ME and Intra_Pred), or decoded using forward motion prediction and intra-prediction), based on data of the processed fifth frame 1332 as indicated by arrow 1366, whereby a processed seventh frame 1358 (for example a completely encoded frame) may be generated. In the fourth step 1350, the number of concurrent jobs may be equal to 4×C_{wav}.

In FIG. 13E, a fifth step 1370 of processing (for example encoding, or for example decoding) is shown. In the fifth step 1370, the partially completed second frame 1312 may be processed (for example encoded using backward motion estimation using macroblock wavefront and intra-prediction (for example by execution of tasks L1_ME and Intra_Pred), or decoded using backward motion prediction and intra-prediction), based on data of the processed third frame 1352 as indicated by arrow 1380, whereby a processed second frame 1372 (for example a completely encoded frame) may be generated. Furthermore, in the fifth step 1370, the partially completed fourth frame 1354 may be processed (for example encoded using forward motion estimation using macroblock wavefront and intra-prediction (for example by execution of tasks L0_ME and Intra_Pred), or decoded using forward motion prediction and intra-prediction), based on data of the processed third frame 1352 as indicated by arrow 1382, whereby a processed fourth frame 1374 (for example a completely encoded frame) may be generated. Furthermore, in the fifth step 1370, the partially completed sixth frame 1356 may be processed (for example encoded using backward motion estimation using macroblock wavefront and intra-prediction (for example by execution of tasks L1_ME and Intra_Pred, or decoded using backward motion prediction and intra-prediction), based on data of the processed seventh frame 1358 as indicated by arrow 1384, whereby a processed sixth frame 1376 (for example a completely encoded frame) may be generated. Furthermore, in the fifth step 1370, the partially completed eighth frame 1336 may be processed (for example encoded using forward motion estimation using macroblock wavefront and intra-prediction (for example by execution of tasks L0_ME and Intra_Pred), or decoded using forward motion prediction and intra-prediction), based on data of the processed seventh frame 1358 as indicated by arrow 1386, whereby a processed eighth frame 1378 (for example a completely encoded frame) may be generated. In the fifth step 1370, the number of concurrent jobs may be equal to 4×C_{wav}. For example, after this step, all frames are completely encoded.

In FIG. 13F, a state 1390 after processing (for example encoding, or for example decoding) is done is shown, wherein the processed first frame 1302, the processed second frame 1372, the processed third frame 1352, the processed fourth frame 1374, the processed fifth frame 1332, the processed sixth frame 1376, the processed seventh frame 1358, the processed eighth frame 1378 and the processed ninth frame 1318 have been generated, for example have been completely encoded.

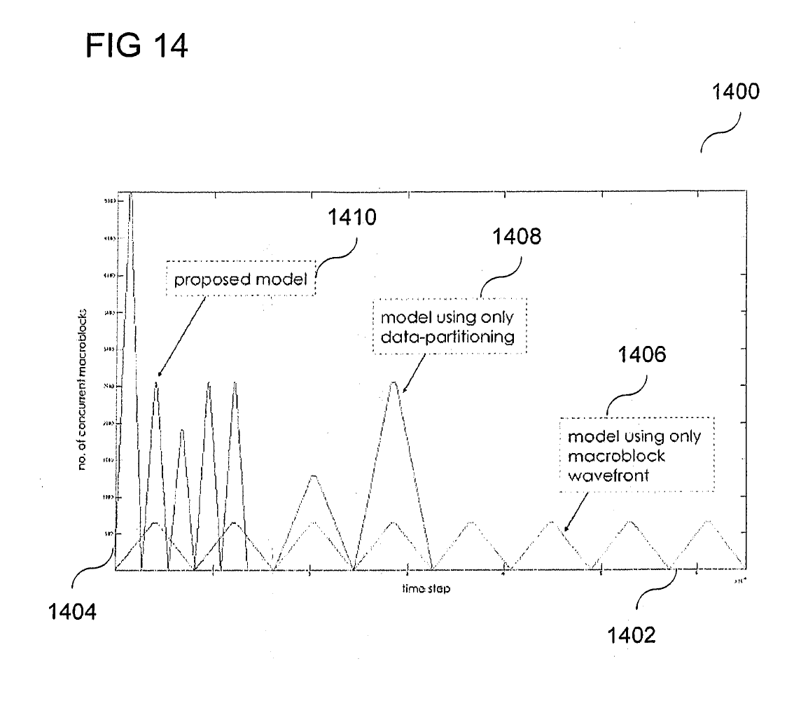

FIG. 14 shows a graph 1400 illustrating the number of concurrent macroblock tasks while processing a GOP of 8 frames in accordance with various embodiments. The horizontal axis 1402 denotes the time step, and the vertical axis denotes the number of concurrent macroblocks. The number of concurrent macroblocks according to various embodiments is shown in a first curve 1410. The number of concurrent macroblocks according to a model using only data-partitioning is shown in second curve 140S. The number of concurrent macroblocks according to a model using only macroblock wavefront is shown in curve third 1406.

For the graph 1400 is may be assumed that there is no limitation on the number of processors and each macroblock only requires a unit time to complete processing. Therefore, for each unit time step, the completion of all concurrent macroblocks that are being processed may be assumed.

In the third curve 1406, the model using only macroblock wavefront may show a periodic saw-tooth pattern. This may be observed and inferred in accordance with FIG. 9. For example at time=4, only the macroblock 908 and the macroblock 914 may be concurrent; at time=5, only the macroblock 910, the macroblock 916 and the macroblock 922 may be concurrent. As the wavefront progress, the number of concurrent macroblock may peak and may decline. For example at time=10, only macroblock 938 and macroblock 944 may be concurrent.

In the second curve 1408, because of the data-partitioning model may allow concurrent processing of multiple independent frames, the distribution of total number of concurrent macroblocks over time may be like a cumulative-saw-tooth pattern since the number of concurrent frame increases in time (within each GOP). It is to be noted that this is also why processing as represented by the second curve 1408 may take only half the time to process the GOP as compared to processing represented by the third curve 1406.

Similar for the processing represented by the first curve 1410, methods according to various embodiments may be able to spawn more concurrent macroblock in each unit time for the processors to consume (hence explained by the higher peaks and steep slope of the saw-tooth graph). Therefore, processing represented by the first curve 1410 may take even less time to complete processing the GOP than processing represented by the second curve 1408.

To demonstrate the effect of generating more tasks for multi-core scalable video encoding, a simulation was set up as follows:
A task may be either a forward or backward prediction for a macroblock.
A task for a particular macroblock may be ready for execution when: The macroblocks in the same slice that are required for the intra-prediction for the current macroblock have finished all their tasks and all the macroblocks of the reference frames for the macroblock have finished all their tasks.
Each task may take 1 time unit to execute.
At the start of each simulation cycle, each processor may pick a task from the task pool for execution during the cycle.
At the end of each cycle, tasks that were picked at the start of the cycle finish execution, possibly may enable the start of previously unavailable tasks.
At the end of the simulation, the speedup is computed as:

No. of cycles required to encode a GOP/Total number of tasks. (1)

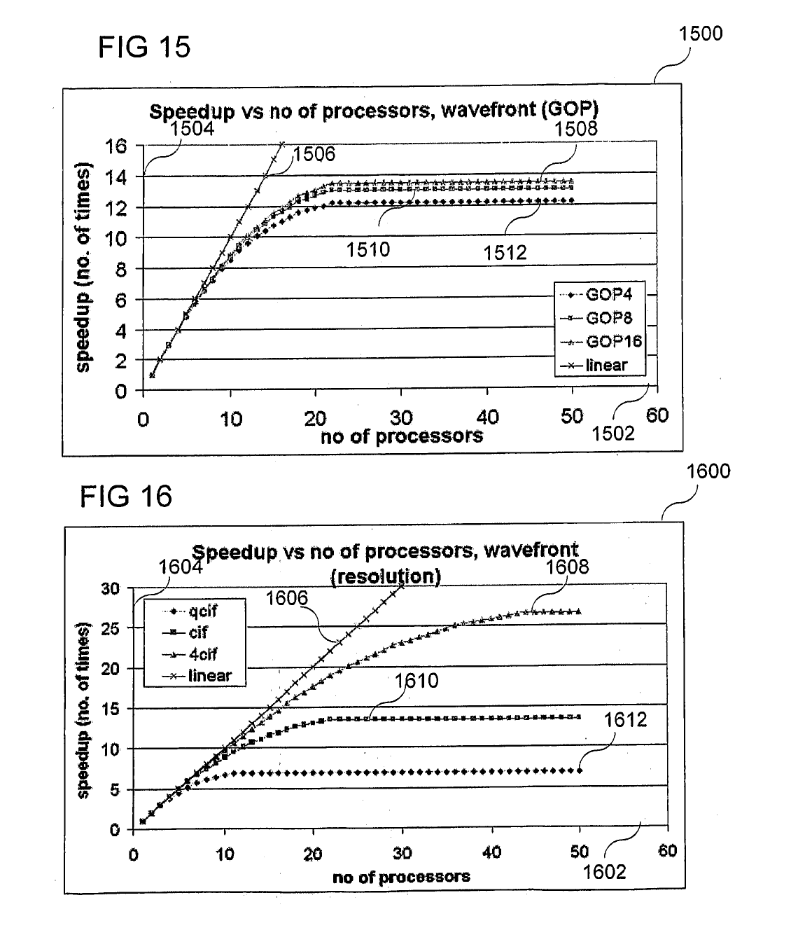

FIG. 15 shows a graph 1500 indicating speedup vs. number of processors for wavefront encoding. The horizontal axis 1502 denotes the number of processors available for parallelization, and the vertical axis 1504 denotes the speedup. Results are shown for a GOP of four pictures (GOP4) in the curve 1512 with diamonds, for a GOP of eight pictures (GOP8) in the curve 1510 with squares, and for a GOP of sixteen pictures (GOP16) in the curve 1508 with triangles. For comparison with the theoretically best possible parallelization, a linear curve 1506 is also plotted. FIG. 15 shows the speedup that is possible with wavefront encoding (for CIF resolution). The encoding of a frame may start only after the encoding of the previous frame is finished.

FIG. 15 shows that GOP size may have little impact on the possible speedup of the wavefront parallelization technique as frames are encoded one after another (the slow startup of the first P-frames where the number of concurrent tasks are limited is more pronounced when the GOP size is small).

FIG. 16 shows a graph 1600 indicating speedup vs. number of processors for wavefront encoding. The horizontal axis 1602 denotes the number of processors available for parallelization, and the vertical axis 1604 denotes the speedup. Results are shown for a resolution of QCIF resolution in the curve 1612 with diamonds, for a resolution of CIF resolution in the curve 1610 with squares, and for resolution of 4CIF (for example corresponding to a resolution of 704 pixels×576 pixels) in the curve 1608 with triangles. For comparison with the theoretically best possible parallelization, a linear curve 1606 is also plotted. FIG. 16 shows the speedup that is possible with wavefront encoding. The encoding of a frame may start only after the encoding of the previous frame is finished.

FIG. 16 shows that the size of a video frame may affect the extent to which it may be parallelized. Since the size of wavefront may be larger when a frame is larger, there may be more tasks that may be processed concurrently.

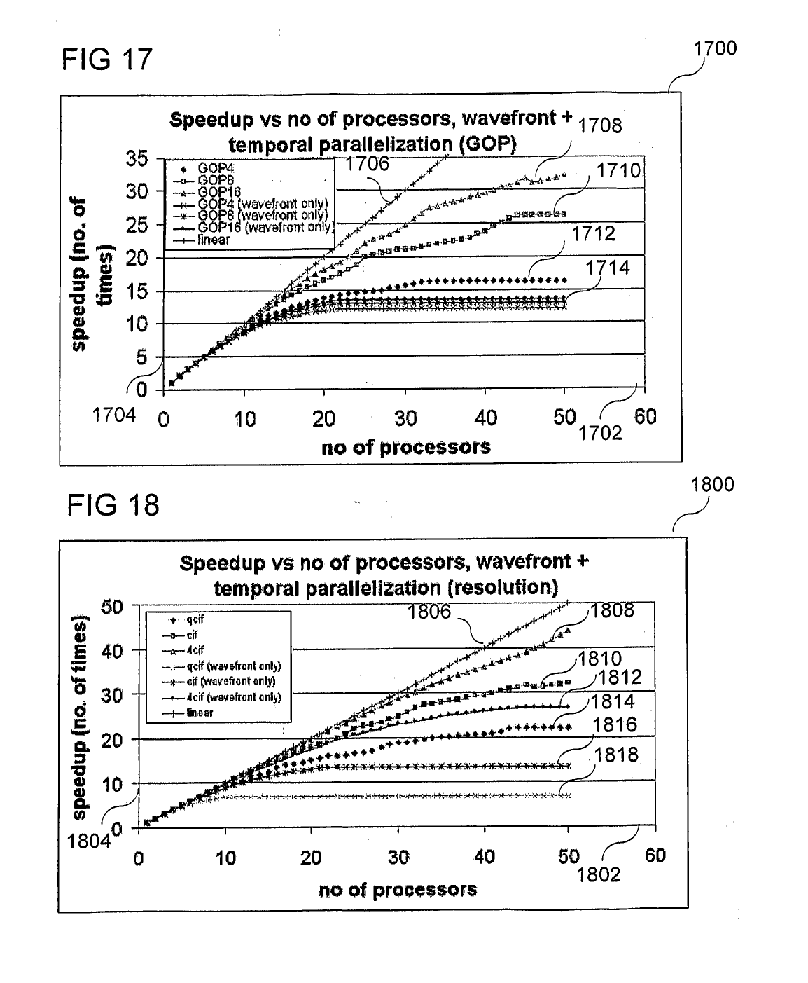

FIG. 17 shows a graph 1700 indicating speedup vs. number of processors for wavefront encoding and temporal parallelization according to an embodiment. The graph 1700 shows the speedup vs. the number of processors at varied GOP size. The horizontal axis 1702 denotes the number of processors available for parallelization, and the vertical axis 1704 denotes the speedup. Results are shown for a GOP of sixteen pictures in the curve 1708 with triangles when performing wavefront encoding and temporal parallelization according to various embodiments, for a GOP of eight pictures in the curve 1710 with squares when performing wavefront encoding and temporal parallelization according to various embodiments, and for a GOP of four pictures in the curve 1712 with diamonds when performing wavefront encoding and temporal parallelization according to various embodiments. For comparison, the curves 1714 corresponding to the curves showing the results with wavefront encoding only as shown in FIG. 15 are also plotted. For comparison with the theoretically best possible parallelization, a linear curve 1706 is also plotted. FIG. 17 shows the speedup that is possible with wavefront encoding and temporal parallelization at CIF resolution.

FIG. 17 shows that the scalability of the proposed parallelization method may be superior (closer to a linear speedup) compared to using only wavefront encoding. The job of video encoding may be allocated to a large number of processors efficiently as a big number of concurrent tasks may be generated with the method according to various embodiments.

FIG. 18 shows a graph 1800 indicating speedup vs. number of processors for wavefront encoding and temporal parallelization according to an embodiment. The graph 1800 shows the speedup vs. the number of processors at resolution for a GOP size of sixteen pictures. The horizontal axis 1802 denotes the number of processors available for parallelization, and the vertical axis 1804 denotes the speedup. Results are shown for a resolution of 4CIF resolution in the curve 1808 with triangles when performing wavefront encoding and temporal parallelization according to various embodiments, for a resolution of CIF resolution in the curve 1810 with squares when performing wavefront encoding and temporal parallelization according to various embodiments, and for a resolution of QCIF resolution in the curve 1814 with diamonds when performing wavefront encoding and temporal parallelization according to various embodiments. For comparison, the curves 1812, 1816 and 1818 corresponding to the curves 1608, 1610 and 1612 showing the results with wavefront encoding only as shown in FIG. 16 are also plotted. For comparison with the theoretically best possible parallelization, a linear curve 1806 is also plotted. FIG. 18 shows the speedup that is possible with wavefront encoding and temporal parallelization at a GOP size of sixteen pictures.

FIG. 18 shows that the algorithm may scale well when the frame size is large. This may be ideal as during the encoding of video of high resolution, a large number of processors may be required to achieve real-time encoding.

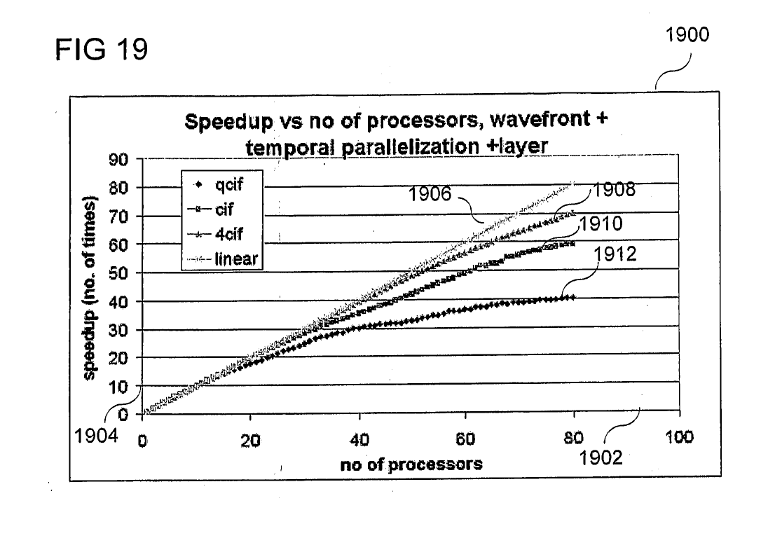

FIG. 19 shows a graph 1900 indicating speedup vs. number of processors if tasks across quality layers are considered according to an embodiment. FIG. 19 shows that scalability may be improved if concurrent tasks across quality layers are considered, for example for a GOP of sixteen pictures and two layers. The horizontal axis 1902 denotes the number of processors available for parallelization, and the vertical axis 1904 denotes the speedup. Results are shown for a resolution of 4CIF resolution in the curve 190S with triangles, for a resolution of CIF resolution in the curve 1910 with squares, and for a resolution of QCIF resolution in the curve 1912 with diamonds. For comparison with the theoretically best possible parallelization, a linear curve 1906 is also plotted.

FIG. 19 shows that more concurrent tasks may be generated if tasks ready for processing in the enhancement layers are considered.

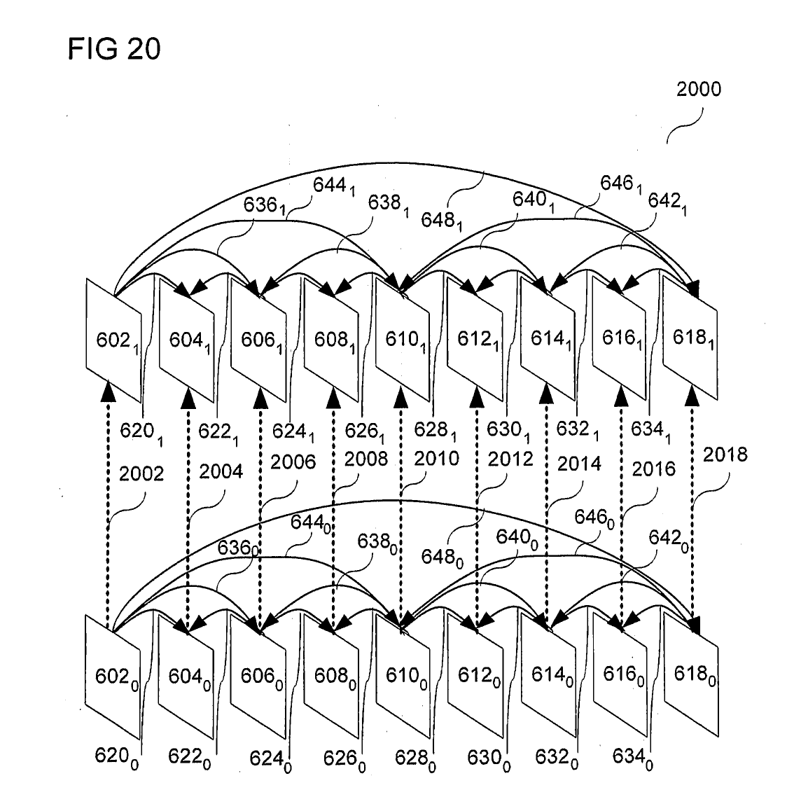

FIG. 20 shows an illustration 2000 of an inter-layer example in accordance with various embodiments. The upper part of the illustration 2000 and the lower part of the illustration each show the hierarchical B-pictures coding structure in accordance with an embodiment as shown in FIG. 6. Therefore, where applicable, the same reference signs as in FIG. 6 are used with index 0 for Layer 0 and index 1 for Layer 1, and duplicate description is omitted here. In various embodiments, in case the optional inter-layer prediction is allowed in the video encoder (for example the SVC), the signals (indicated by the dotted arrow lines 2002 to 2018) may be used to indicate to frames in Layer 1 that the corresponding frames in Layer 0 is completed and that the corresponding frames in Layer 1 may begin processing (i.e. may be begun to be processed), i.e. may begin performing its key tasks (i.e. it may be begun to perform the key tasks of the respective frame), for example as outlined in FIG. 11A and FIG. 11B.

For example, a signal indicated by the first arrow 2002 may indicate to the first frame 602₁ in Layer 1 that the corresponding first frame 602₀ in Layer 0 is completed and that first frame 602₁ in Layer 1 may begin processing. For example, a signal indicated by a first arrow 2002 may indicate to the first frame 602₁ in Layer 1 that the corresponding first frame 602₀ in Layer 0 is completed and that the first frame 602₁ in Layer 1 may begin processing. For example, a signal indicated by a second arrow 2004 may indicate to the second frame 604₁ in Layer 1 that the corresponding second frame 604₀ in Layer 0 is completed and that the second frame 604₁ in Layer 1 may begin processing. For example, a signal indicated by a third arrow 2006 may indicate to the third frame 606₁ in Layer 1 that the corresponding third frame 606₀ in Layer 0 is completed and that the third frame 606₁ in Layer 1 may begin processing. For example, a signal indicated by a fourth arrow 2008 may indicate to the fourth frame 608₁ in Layer 1 that the corresponding fourth frame 608₀ in Layer 0 is completed and that the fourth frame 608₁ in Layer 1 may begin processing. For example, a signal indicated by a fifth arrow 2010 may indicate to the fifth frame 610₁ in Layer 1 that the corresponding fifth frame 610₀ in Layer 0 is completed and that the fifth frame 610₁ in Layer 1 may begin processing. For example, a signal indicated by a sixth arrow 2012 may indicate to the sixth frame 612₁ in Layer 1 that the corresponding sixth frame 612₀ in Layer 0 is completed and that the sixth frame 612₁ in Layer 1 may begin processing. For example, a signal indicated by a seventh arrow 2014 may indicate to the seventh frame 614₁ in Layer 1 that the corresponding seventh frame 614₀ in Layer 0 is completed and that the seventh frame 614₁ in Layer 1 may begin processing. For example, a signal indicated by an eighth arrow 2016 may indicate to the eighth frame 616₁ in Layer 1 that the corresponding eighth frame 616₀ in Layer 0 is completed and that eighth frame 616₁ in Layer 1 may begin processing. For example, a signal indicated by a ninth arrow 2018 may indicate to the ninth frame 618₁ in Layer 1 that the corresponding ninth frame 618₀ in Layer 0 is completed and that the ninth frame 618₁ in Layer 1 may begin processing. In case inter-layer prediction is not active in the video encoder, such signals may not be necessary and processing as illustrated in illustration 2000 may not be necessary.

According to various embodiments, a method may be provided to parallel-process video data (for example a method for parallel video encoding; for example a method for parallel video decoding). Using data and task partitioning approach, for example a data and functional partitioning approach, for example a data and task parallelization model for hierarchical prediction structure in video coding, the method may maximize the number of concurrent tasks for encoding a group of video frames to obtain good performance scalability of video encoder with additional processors or processor-cores. The method may be applied to the hierarchical coding structure that is used in Scalable Video Coding (SVC) standard.

According to various embodiments, parallelism in SVC's hierarchical B-pictures (HB) coding structure may be utilized.

According to various embodiments, the number of concurrent jobs may be maximized from the HB structure: by using data portioning (on a frame, macroblock level) and by functional partitioning (using intra-prediction, motion estimation, etc.).

According to various embodiments, a good speedup vs. number of CPUs performance may be achieved.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. An image encoding method, comprising:
a first partial encoding step, wherein first partially encoded image data is generated based on first input data after the first input data is available;
a second partial encoding step, wherein second partially encoded image data is generated based on second input data after the second input data is available, before the first input data is available; and
an encoded image data generating step, wherein encoded image data is generated based on the first partially encoded image data and the second partially encoded image data;
wherein the first input data comprises encoded image data of a preceding image and the second input data comprises encoded image data of a successive image or wherein the first input data comprises encoded image data of a successive image and the second input data comprises encoded image data of a preceding image.

2. The image encoding method of claim 1, wherein the first partial encoding step comprises at least one of a forward motion estimation step and a backward motion estimation step.

3.-7. (canceled)

8. An image decoding method, comprising:
a first partial decoding step, wherein first partially decoded image data is generated based on first input data after the first input data is available;
a second partial decoding step, wherein second partially decoded image data is generated based on second input data after the second input data is available, before the first input data is available; and
a decoded image data generating step, wherein decoded image data is generated based on the first partially decoded image data and the second partially decoded image data;
wherein the first input data comprises decoded image data of a preceding image and the second input data comprises decoded image data of a successive image or wherein the first input data comprises decoded image data of a successive image and the second input data comprises decoded image data of a preceding image.

9. The image decoding method of claim 8,
wherein the first partial decoding step comprises at least one of a forward motion prediction step and a backward motion prediction step.

10-12. (canceled)

13. The image encoding method of claim 1, wherein the second partial encoding step comprises at least one of a forward motion estimation step and a backward motion estimation step.

14. The image encoding method of claim 1,
wherein the first partial encoding step comprises a forward motion estimation step and the second partial encoding step comprises a backward motion estimation step.

15. The image encoding method of claim 1,
wherein the first partial encoding step comprises a backward motion estimation step and the second partial encoding step comprises a forward motion estimation step.

16. The image encoding method of claim 1, further comprising:
a third partial encoding step, wherein third partially encoded image data is generated based on the first partially encoded image data and the second partially encoded image data;
wherein in the encoded image data generating step, the encoded image data is generated based on the first partially encoded image data, the second partially encoded image data and the third partially encoded image data.

17. The image encoding method of claim 1,
wherein the encoded image data generated in the encoded image data generating step comprises at least one of encoded frame data, encoded slice data and encoded macroblock data.

18. The image decoding method of claim 8,
wherein the second partial decoding step comprises at least one of a forward motion prediction step and a backward motion prediction step.

19. An image encoding apparatus, comprising:
a first partial encoder configured to generate first partially encoded image data based on first input data after the first input data is available;
a second partial encoder configured to generate second partially encoded image data based on second input data after the second input data is available, before the first input data is available; and
an encoded image data generator configured to generate encoded image data based on the first partially encoded image data and the second partially encoded image data;
wherein the first input data comprises encoded image data of a preceding image and the second input data comprises encoded image data of a successive image or wherein the first input data comprises encoded image data of a successive image and the second input data comprises encoded image data of a preceding image.

20. An image decoding apparatus, comprising:
a first partial decoder configured to generate first partially decoded image data based on first input data after the first input data is available;
a second partial decoder configured to generate second partially decoded image data based on second input data after the second input data is available, before the first input data is available; and
a decoded image data generator configured to generate decoded image data based on the first partially decoded image data and the second partially decoded image data;
wherein the first input data comprises decoded image data of a preceding image and the second input data comprises decoded image data of a successive image or wherein the first input data comprises decoded image data of a successive image and the second input data comprises decoded image data of a preceding image.
